(19) United States
(12) Patent Application Publication
(10) Pub. No.: US 2026/0101026 A1
(43) Pub. Date: Apr. 9, 2026

(54) HIGH-QUALITY THREE DIMENSIONAL ASSET GENERATION

(71) Applicant: NVIDIA Corporation, Santa Clara, CA (US)

(72) Inventors: Chen-Hsuan Lin, San Jose, CA (US); Tsung-Yi Lin, Sunnyvale, CA (US); Ming-Yu Liu, Redwood City, CA (US); Xiaohui Zeng, Toronto (CA); Zhaoshuo Li, Santa Clara, CA (US); Zekun Hao, New York, NY (US); Donglai Xiang, San Jose, CA (US); Qianli Ma, Zürich (CH); Jingyi Jin, San Jose, CA (US); Fangyin Wei, Santa Clara, CA (US); Yin Cui, Mountain View, CA (US)

(21) Appl. No.: 19/170,298

(22) Filed: Apr. 4, 2025

Related U.S. Application Data
(60) Provisional application No. 63/704,500, filed on Oct. 7, 2024.

(51) Int. Cl. H04N 13/275; G06T 3/4046; G06T 15/04; G06T 17/20; H04N 13/156; H04N 13/282

(52) U.S. Cl. CPC H04N 13/275; G06T 3/4046; G06T 15/04; G06T 17/20; H04N 13/156; H04N 13/282; G06T 2210/36

(57) ABSTRACT

Embodiments of the present disclosure provide systems and methods for generating a three-dimensional (3D) asset. A first multi-view diffusion model generates a multi-view image based on an input prompt. A second multi-view diffusion model generates a multi-view surface normal image based on the input prompt and the multi-view image. A 3D reconstruction engine processes the multi-view image and the multi-view surface normal image to generate an intermediate 3D representation of the object, including a polygon mesh and a low-resolution texture map. A rendering engine renders a second multi-view image based on the intermediate 3D representation. A third multi-view diffusion model processes the input prompt and the second multi-view image to generate a high-resolution multi-view image. The 3D reconstruction engine upscales the low-resolution texture map based on the high-resolution multi-view image and generates the 3D asset, which includes the polygon mesh and the upscaled texture map.

### CLAIM OF PRIORITY

This application claims the benefit of U.S. Provisional Application No. 63/704,500, titled “High-Quality Quad Mesh Generation With PBR Materials” and filed Oct. 7, 2024, the entire contents of which are incorporated herein by reference.

### BACKGROUND

The creation of detailed digital 3D assets is essential for developing scenes, characters, and environments across various digital domains. This capability is invaluable to industries such as video game design, extended reality, film production, and simulation. However, for 3D content to be production-ready, it must meet industry standards, including precise mesh structures, high-resolution textures, and material maps. Consequently, producing such high-quality 3D content is often an exceedingly complex and time-intensive process. As demand for 3D digital experiences grows, the need for efficient, scalable solutions in 3D asset creation will become increasingly important.

Recent research has investigated training of AI models for 3D asset generation. A significant challenge, however, is the limited availability of 3D assets suitable for model training. Creating 3D content requires specialized skills and expertise, making such assets much scarcer than other visual media like images and videos. This scarcity raises a key question of how to design scalable models to generate high-quality 3D assets from image and video data efficiently.

### SUMMARY

Embodiments of the present disclosure provide systems and methods for generating a three-dimensional (3D) asset using one or more neural networks. In at least one embodiment, a first multi-view diffusion model is configured to receive and process an input prompt to generate a muti-view image of an object. A second multi-view diffusion model is configured to receive and process the input prompt and the multi-view image to generate a multi-view surface normal image of the object. A 3D reconstruction engine is configured to receive and process the multi-view image and the multi-view surface normal image to generate an intermediate 3D representation of the object, wherein the intermediate 3D representation includes a polygon mesh and a low-resolution texture map. A rendering engine is configured to render a second multi-view image based on the intermediate 3D representation of the object. A third multi-view diffusion model is configured to receive and process the input prompt and the rendered second multi-view image to generate a high-resolution multi-view image. The 3D reconstruction engine is further configured to upscale the low-resolution texture map based on the high-resolution multi-view image and provide the 3D asset comprising the polygon mesh and the upscaled texture map.

### BRIEF DESCRIPTION OF THE DRAWINGS

The present systems and methods for high-quality 3D asset generation are described in detail below with reference to the attached drawing figures, wherein:

FIG. 1 illustrates a flowchart of a method for generating a three-dimensional (3D) asset based on a text prompt, in accordance with an embodiment.

FIG. 2A illustrates a block diagram of an example system suitable for use in implementing one or more embodiments of the present disclosure.

FIG. 2B illustrates a block diagram of an example system suitable for use in implementing one or more embodiments of the present disclosure.

FIG. 3A illustrates an example of a plurality of multi-view red-green-blue (RGB) images generated by a diffusion model based on a text prompt, in accordance with an embodiment.

FIG. 3B illustrates an example of a plurality of surface normal images generated by a diffusion model based on RGB images and a text prompt, in accordance with an embodiment.

FIG. 3C illustrates an example neural representation of a 3D asset using triplanes, in accordance with an embodiment.

FIG. 3D illustrates an example 3D mesh associated with texture and material maps of the 3D asset to be generated, in accordance with an embodiment.

FIG. 3E illustrates upscaling a texture map, in accordance with an embodiment.

FIG. 3F illustrates exemplary layouts of camera poses for generating multi-view images, in accordance with an embodiment.

FIG. 4 is a conceptual diagram of a processing system implemented using a PPU, suitable for use in implementing some embodiments of the present disclosure.

FIG. 5A illustrates an exemplary system in which the various architecture and/or functionality of the various previous embodiments may be implemented.

FIG. 5B illustrates components of an exemplary system that can be used to train and utilize machine learning, in at least one embodiment.

FIG. 6 illustrates an exemplary streaming system suitable for use in implementing some embodiments of the present disclosure.

### DETAILED DESCRIPTION

The present disclosure provides systems and methods for high-quality 3D asset generation. According to one or more embodiments, the present disclosure provides systems and methods for generating 3D assets based on a prompt (e.g., in the form of text and/or an image) using a novel text and/or image-to-3D generation pipeline that includes a combination of AI models. In at least one embodiment, a multi-view diffusion model, which receives a prompt in the form of text and/or an image, generates a multi-view RGB image. In at least one embodiment, a multi-view control net diffusion model, which is conditioned with RGB images, generates geometric information corresponding to the received prompt. In at least one embodiment, a Transformer-based reconstruction model, which receives both RGB images and geometric information (e.g., surface normal images) as input, generates a neural representation of the 3D asset (e.g., in the form of triplanes). In at least one embodiment, an upscaling control net, which is conditioned with rasterized RGB images generated based on a 3D mesh and low-resolution texture and/or material maps, generates high-resolution multi-view images, and low-resolution texture and/or material maps are upsampled based on the high-resolution multi-view images to provide high-resolution texture and/or material maps. In at least one embodiment, a quad-mesh and low-resolution texture and material maps generated from the neural representation of the 3D asset are rasterized to provide multi-view RGB and surface normal images, which—along with the prompt—condition the upscaling control net. In at least one embodiment, the high-resolution multi-view RGB image is back-projected on the low-resolution texture and material maps to generate the high-resolution texture and material maps.

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles, semi-autonomous vehicles (e.g., in one or more advanced driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types.

Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations, systems implemented using large language models (LLMs), systems implemented using vision language models (VLMs), systems for performing light transport simulation, systems for performing collaborative content creation for 3D assets, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The present disclosure provides for efficiently generating high-quality 3D assets from received prompts using a pipeline of sequential modules. The generated 3D asset includes a quadrilateral 3D mesh representation with clean topologies, which allow for easier manipulation and precise adjustments of the generated 3D asset, making the generated 3D asset well-suited for various downstream editing tasks and rendering applications. The fully consistent, high fidelity 3D asset is generated based on multi-view images generated by multiple diffusion models, that provide superior texture to the 3D asset, without artifacts and shadows. In order for the 3D asset to be of high quality, the multi-view images that are used to generate the 3D asset should be visually consistent across different viewpoints. In one or more embodiments, the visually consistent multi-view images are generated by training a diffusion model across different numbers of viewpoints. Generating more views allows for broader coverage of the different regions of the 3D asset in the multi-view images.

In one or more embodiments, a first module receives a prompt and synthesizes RGB and surface normal images of the object described in the received prompt, at multiple viewpoints, using diffusion models. The multi-view RGB and surface normal images are then used by a reconstruction model to generate a neural 3D representation of the 3D asset. In one or more embodiments, the neural representation encodes a 3D field of RGB albedo colors (3 channels) as well as material properties (2 channels representing roughness and metallic).

In one or more embodiments, a second module processes the neural 3D representation of the 3D asset to generate a quadrilateral 3D mesh representation of the 3D asset. The quadrilateral 3D mesh representation allows for precise adjustments of the generated 3D asset, making the generated 3D asset well-suited for downstream editing tasks and rendering applications. The second module also uses the neural 3D representation (encoding color and material properties) to prepare a texture map (e.g., color) and a material map (e.g., roughness and metallic) of the surface of the quadrilateral 3D mesh.

A third module takes the generated quadrilateral 3D representation and upscales the texture map, producing a 3D quadrilateral mesh with sharper textures while retaining the same geometry. The process of upscaling the texture maps eliminates undesirable properties in the final generated 3D asset (e.g., shadow artifacts), thereby making the generated 3D asset of high quality with detailed geometry, clean shape topologies, high-resolution textures, and materials for downstream processing and applications.

Thus, in one or more embodiments, the 3D asset includes (i) a quadrilateral three-dimensional (3D) mesh representation, (2) a texture map embedded with the 3D mesh that encodes albedo RGB color of the surface of the 3D asset, and (3) a material map embedded with the 3D mesh that represents roughness and metallic properties of the surface of the 3D asset.

In one or more embodiments, a system includes processing circuitry to generate a three-dimensional (3D) asset using one or more neural networks. The processing circuitry is configured to implement: (i) a first multi-view diffusion model configured to receive and process an input prompt to generate a muti-view image of an object for which the 3D asset is to be generated, (ii) a second multi-view diffusion model configured to receive and process the input prompt and the multi-view image to generate a multi-view surface normal image of the object, (iii) a 3D reconstruction engine configured to receive and process the multi-view image and the multi-view surface normal image to generate an intermediate 3D representation of the object, wherein the intermediate 3D representation comprises a polygon mesh and a low-resolution texture map, (iv) a rendering engine configured to render a second multi-view image based on the intermediate 3D representation of the object, and (v) a third multi-view diffusion model configured to receive and process the input prompt and the rendered second multi-view image to generate a high-resolution multi-view image. The system further includes one or more memories to store parameters associated with the one or more neural networks. The 3D asset includes the polygon mesh and a high-resolution texture map generated by upscaling, by the 3D reconstruction engine, the low-resolution texture map based on the high-resolution multi-view image.

According to at least one embodiment of the system, the input prompt is text, an image, or both.

According to at least one embodiment of the system, the multi-view surface normal image generated by the second multi-view diffusion model comprises surface normals of the object in the multi-view image, and the second multi-view diffusion model is conditioned on both the multi-view image and the received prompt.

According to at least one embodiment of the system, the 3D reconstruction engine is further configured to: generate a 3D neural representation of the object based on the multi-view image and the multi-view surface normal image and generate the polygon mesh and the low-resolution texture map based on the 3D neural representation of the object. In at least one embodiments, the 3D neural representation is generated based on a Transformer-based model. In at least one embodiment, the 3D reconstruction engine is further configured to generate a low-resolution material map based on the 3D neural representation of the object. In at least one embodiment, the low-resolution texture map and a low-resolution material map are mapped to the polygon mesh using a UV map.

According to at least one embodiment of the system, the 3D reconstruction engine is further configured to: extract a dense triangular mesh based on the 3D neural representation, retopologize the dense triangular mesh to a simplified 3D quad mesh, and generate the UV map based on the simplified 3D quad mesh and the 3D neural representation. In at least one embodiment, the UV map is generated by assigning each vertex of the simplified 3D quad mesh with a corresponding UV-coordinate in a 2D space of the UV map. In at least one embodiment, the 3D reconstruction engine extracts the dense triangular mesh from the 3D neural representation using a marching cubes algorithm.

In one or more embodiments, a method for generating a three-dimensional (3D) asset includes (i) receiving and processing, using a first multi-view diffusion model, an input prompt to generate a muti-view image of an object for which the 3D asset is to be generated, (ii) receiving and processing, using a second multi-view diffusion model, the input prompt and the multi-view image to generate a multi-view surface normal image of the object, (iii) receiving and processing, using a 3D reconstruction engine, the multi-view image and the multi-view surface normal image to generate an intermediate 3D representation of the object, wherein the intermediate 3D representation comprises a polygon mesh and a low-resolution texture map, (iv) rendering, using a rendering engine, a second multi-view image based on the intermediate 3D representation, (v) receiving and processing, using a third multi-view diffusion model the input prompt, the rendered second multi-view image, and the low-resolution texture map to generate a high-resolution multi-view image, (vi) upscaling, using the 3D reconstruction engine, the low-resolution texture map based on the high-resolution multi-view image, and (vii) providing the 3D asset, the 3D asset comprising the polygon mesh and the upscaled texture map.

According to at least one embodiment of the method, the input prompt is text, an image, or both.

According to at least one embodiment of the method, the multi-view surface normal image generated by the second multi-view diffusion model comprises surface normals of the object in the multi-view image, and the second multi-view diffusion model is conditioned on both the multi-view image and the received input prompt.

According to at least one embodiment of the method, the rendering engine is based on a Transformer-based model.

According to at least one embodiment of the method, generating the intermediate 3D representation of the object includes: generating a 3D neural representation of the object based on the multi-view image and the multi-view surface normal image, and generating the polygon mesh and the low-resolution texture map based on the 3D neural representation of the object. In at least one embodiment, the method further includes generating a low-resolution material map based on the 3D neural representation of the object.

According to at least one embodiment of the method, the low-resolution texture map and a low-resolution material map are mapped to the polygon mesh using a UV map.

According to at least one embodiment of the method, the polygon mesh generated by: extracting a dense triangular mesh based on a 3D neural representation, retopologizing the dense triangular mesh to a simplified 3D quad mesh, and generating the UV map based on the simplified 3D quad mesh and the 3D neural representation.

According to at least one embodiment of the method, the UV map is generated by assigning each vertex of the simplified 3D quad mesh with a corresponding UV-coordinate in a 2D space of the UV map.

According to one or more embodiments, non-transitory computer-readable media is provided having stored thereon executable instructions that, when executed by processing circuitry, cause the processing circuitry to perform the method for generating a three-dimensional asset and any embodiment thereof.

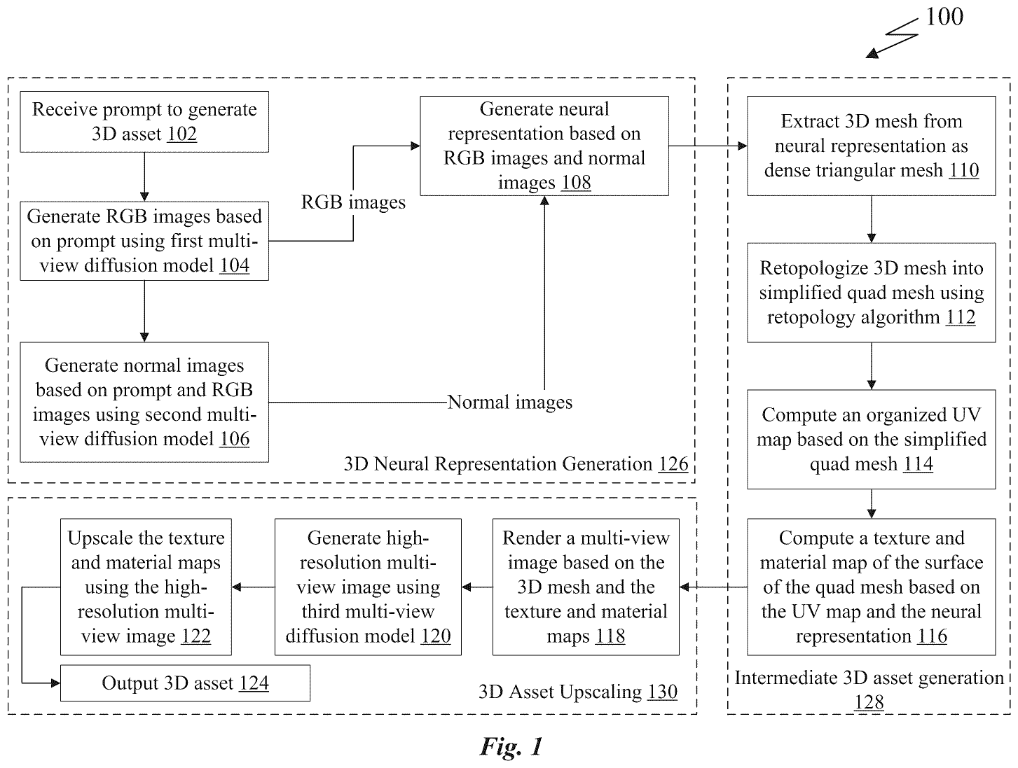

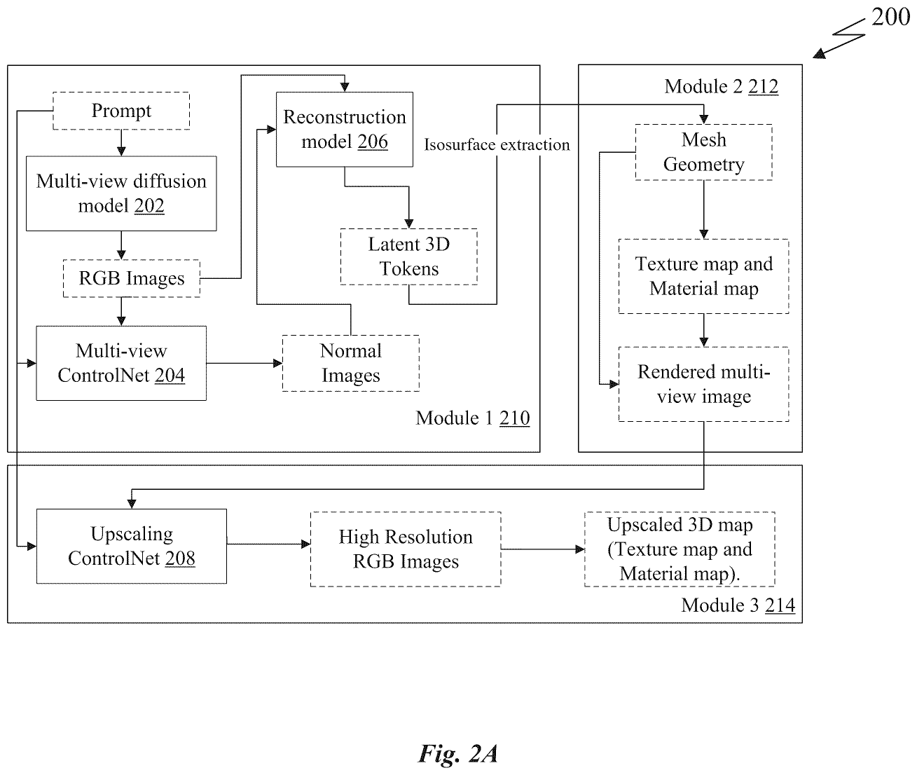

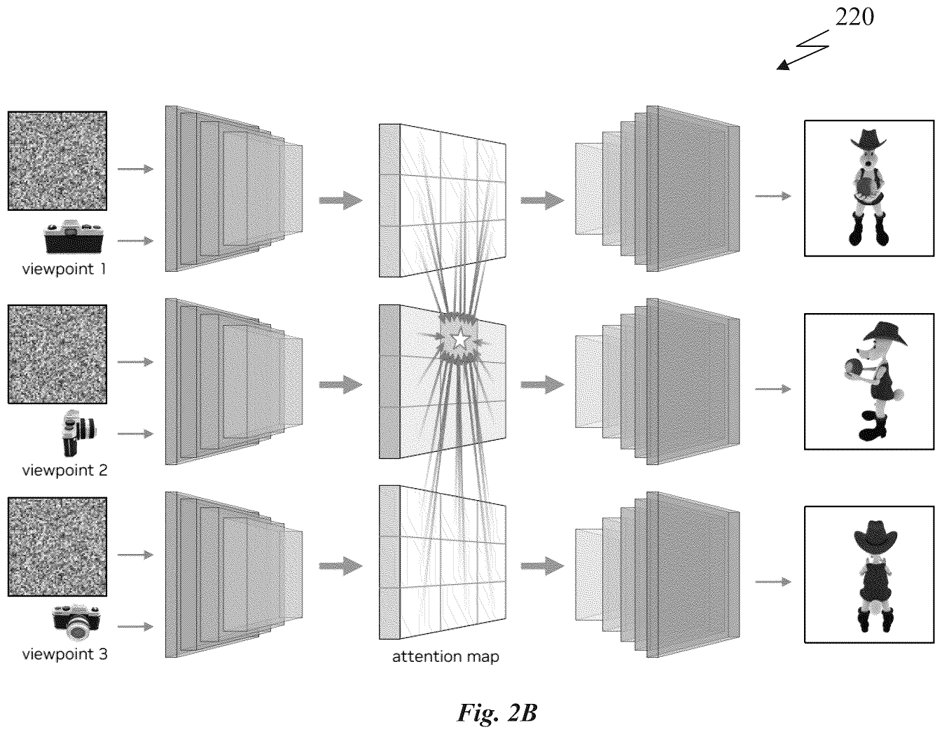

FIG. 1 is a flow diagram of a method 100 for generating high-quality three-dimensional (3D) assets, in accordance with an embodiment. Each block of method 100, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 100 is described, by way of example, with respect to the system of FIG. 2. However, this method may additionally or alternatively be executed by any one system, or any combination of systems, including, but not limited to, those described herein. Furthermore, persons of ordinary skill in the art will understand that any system that performs method 100 is within the scope and spirit of embodiments of the present disclosure.

FIG. 1 is a flow diagram illustrating a method for 3D asset generation, e.g., a method for generating 3D assets from text input. The method 100 includes a 3D neural representation generation phase 126, an intermediate 3D asset generation phase 128, and a 3D asset upscaling phase 130.

The 3D neural representation generation phase 126 receives, as input, a prompt to generate a 3D asset and generates 3D neural representation of the asset as output. At 102, the method 100 receives the prompt as input. In at least one embodiment, the prompt is a text prompt. In at least one embodiment, the text prompt provides a written description of an object corresponding to the 3D asset to be generated. In at least one embodiment, the prompt additionally and/or alternatively includes an image corresponding to the 3D asset to be generated. In at least one embodiment, the method 100 converts the image to tokens in a latent space, e.g., a latent space into which the text prompt is projected. A running example is used herein to demonstrate the operation and improved functionality and performance of an embodiment of method 100. The running example begins with the method 100 receiving a text prompt of “A steampunk robot turtle with rusty mechanical parts.” The method 100, as described later in the application, generates a 3D asset based on the text prompt. Additionally, and/or alternatively, other text prompts can be provided as input. For example, “A bear wearing a cowboy outfit,” “A knight's armor on a stand,” “A phonograph made of wood and gold,” can be other prompts that can be provided as text input to generate a corresponding 3D asset.

At 104, the method 100 generates, using a first multi-view diffusion model, a multi-view image based on the received prompt. In at least one embodiment, the multi-view image comprises a plurality of images, each of which corresponds to a canonical view (i.e., a unique perspective, or view) of the 3D asset to be generated. In at least one embodiment, each image is an RGB image that provides, for each pixel thereof, a value for each of three-color channels (i.e., red, green, and blue). In at least one embodiment, the first multi-view diffusion model is a base model configured to synthesize RGB images of an object corresponding to the prompt.

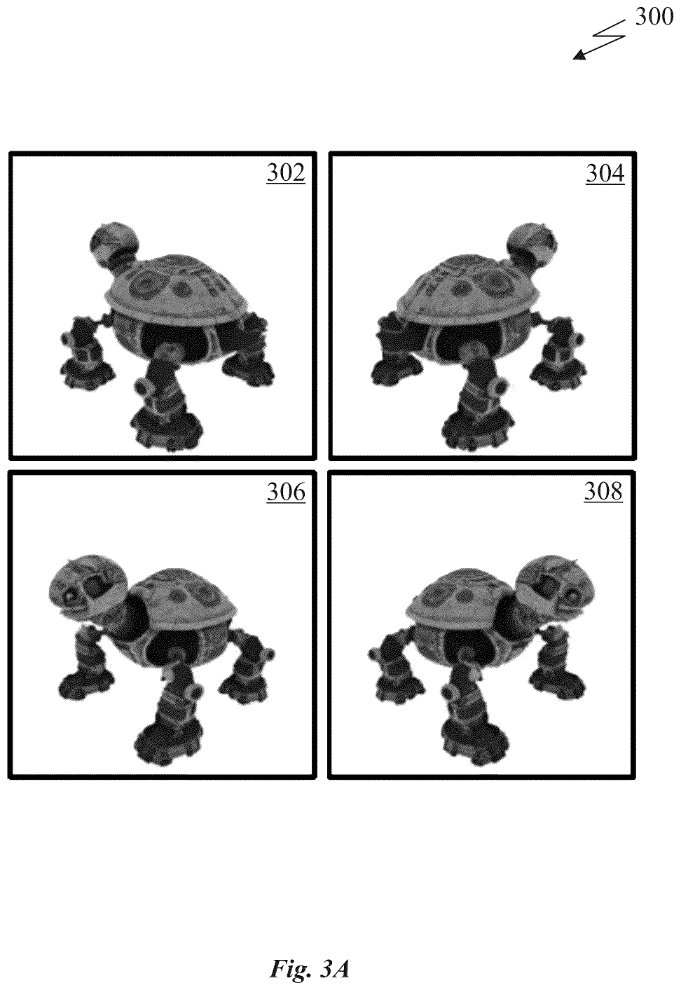

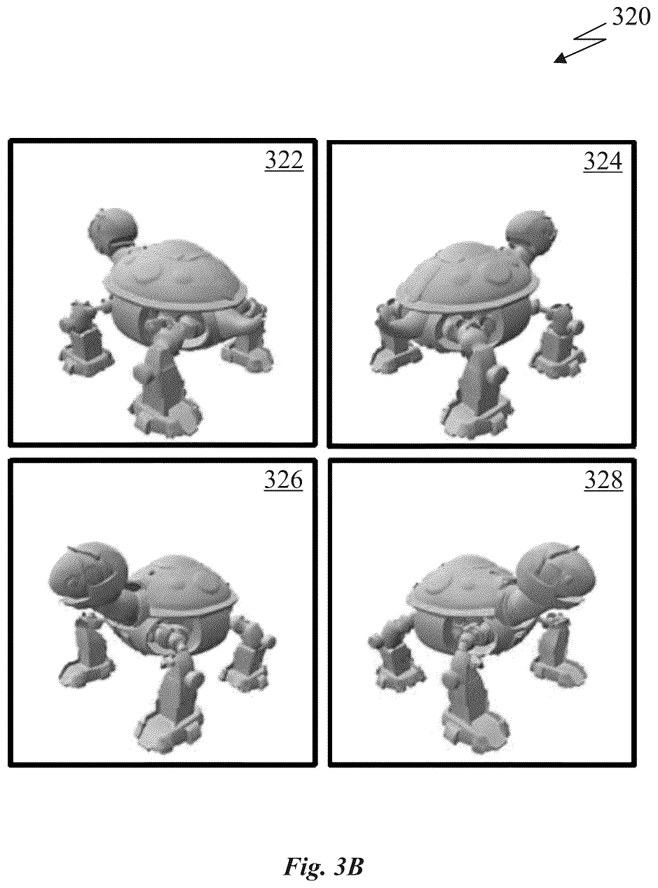

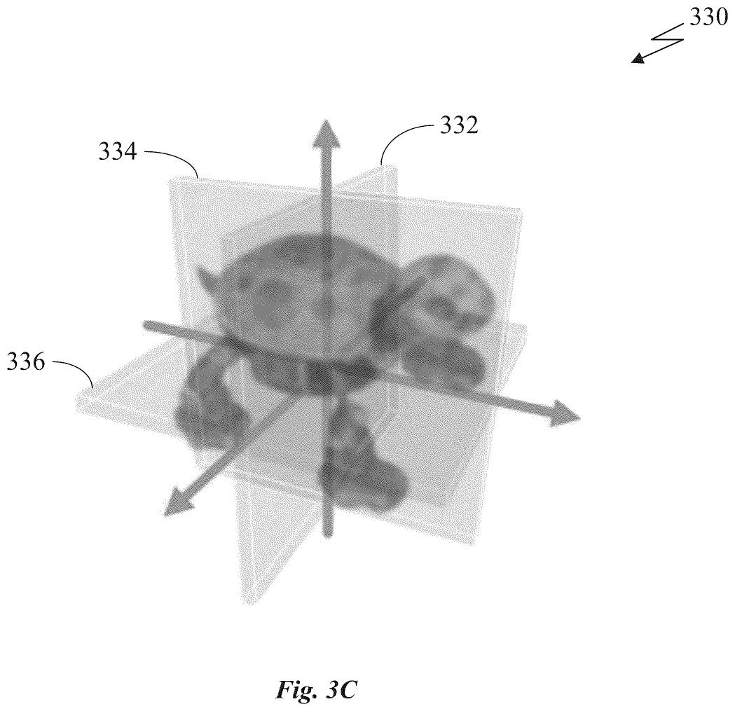

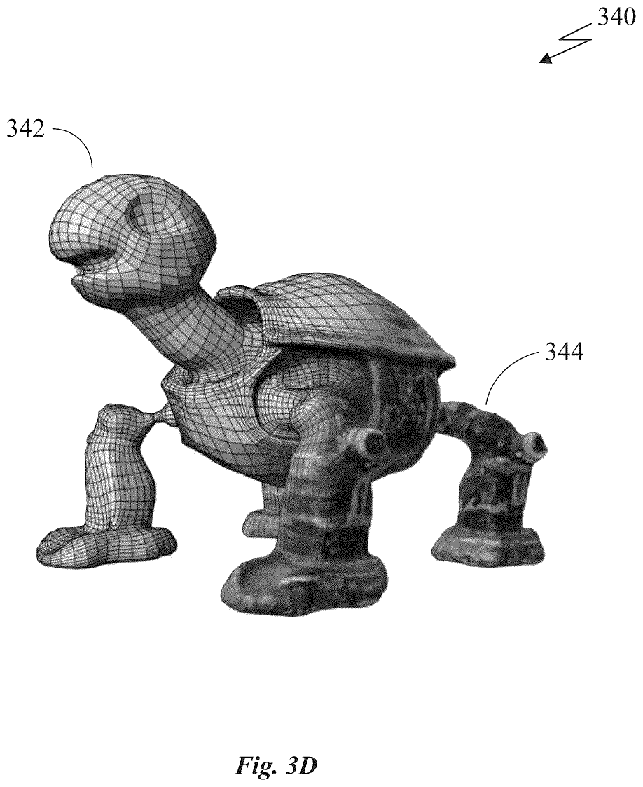

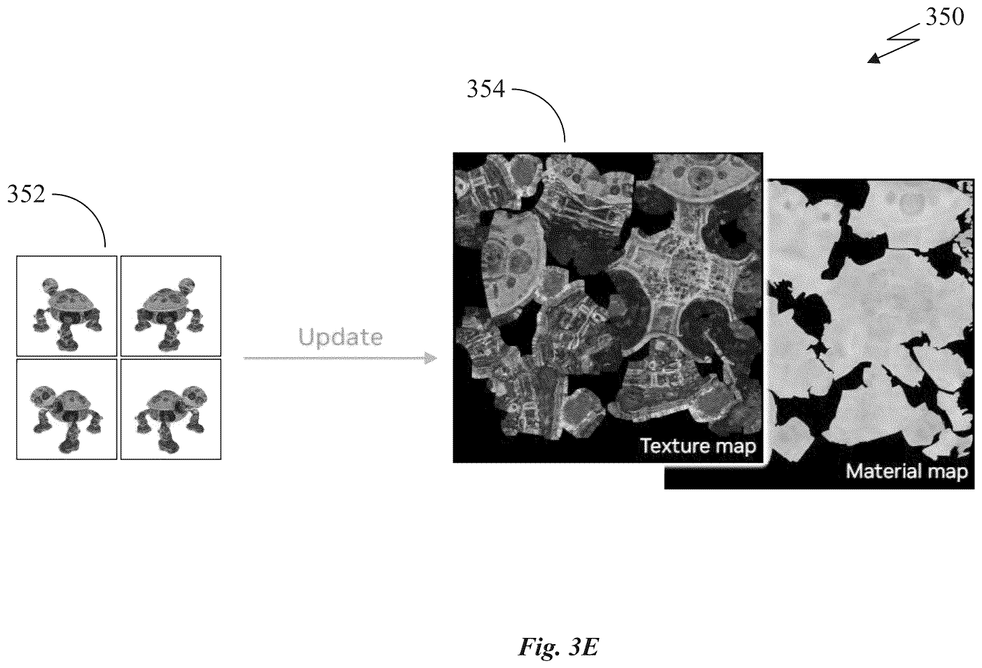

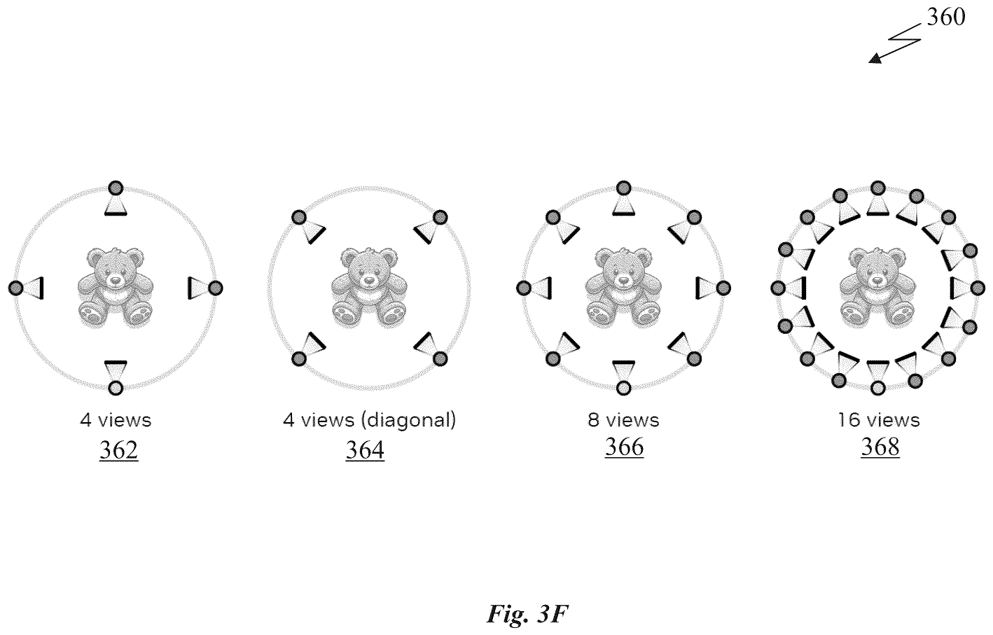

FIG. 3A illustrates an example of a multi-view image generated at 104 using the first multi-view diffusion model. Based on the text prompt provided above, the generated RGB images include a steampunk robot turtle with rusty mechanical parts. Images 302, 304, 306, and 308 as shown in FIG. 3A depict a steampunk turtle with rusty metal parts, as specified in the prompt, from different unique perspectives or views. For example, images 302 and 304 are rear-perspective RGB images, while images 306 and 308 are front-perspective RGB images of the 3D asset to be generated.

According to at least one embodiment, the different views of the multi-view RGB images, as shown in FIG. 3A, are generated based on predefined camera positions around the entity for which the 3D asset is to be generated. In at least one embodiment, the cameras are equally distributed around the 3D asset that is to be generated. The predefined camera positions can be determined based on the number of cameras that can be positioned around the entity. According to at least one embodiment, the greater the number of views, the better the accuracy of the 3D asset that is ultimately generated.

FIG. 3F illustrates exemplary camera layouts for generating multi-view RGB images, as shown in FIG. 3A, in accordance with an embodiment. Layout 362 of FIG. 3F depicts four (4) cameras arranged around an entity for which the 3D asset is to be generated. Layout 364 of FIG. 3F depicts an alternate layout of four (4) cameras that are diagonally arranged around the entity for which the 3D asset is to be generated. Layout 366 of FIG. 3F depicts eight (8) cameras arranged around the entity for which the 3D asset is to be generated. Layout 368 of FIG. 3F depicts sixteen (16) cameras arranged around the entity for which the 3D asset is to be generated. In accordance with some embodiments, the positions of the cameras are set at various azimuth angles at a fixed elevation (e.g., twenty (20) degrees).

At 106, the method 100 generates, using a second multi-view diffusion model, a multi-view normal image. The second multi-view diffusion model is conditioned on both the received prompt and the multi-view RGB image generated at 104 and is configured to synthesize a multi-view normal image that encodes geometric information pertaining to the object depicted in the multi-view RGB image generated at 104. The normal images provide, for each respective pixel thereof, a value for each of three directional channels (i.e., an x-direction, a y-direction, and a z-direction) to encode a direction of a surface normal of the object depicted therein at the respective pixel. The multi-view normal image serve to enhance the visual quality and details of the 3D asset that is ultimately generated. In at least one embodiment, the surface normals are represented as three-dimensional (3D) unit vectors.

FIG. 3B illustrates an example of a multi-view normal image generated at 106 using the second multi-view diffusion model. In at least one embodiment, the normal images can be generated based on the multi-view RGB image generated at 104. As shown in FIG. 3B, the normal images 322, 324, 326, and 328 are based on the RGB images 302, 304, 306, and 308 respectively. Similar to the RGB images as shown in FIG. 3A, the normal images 322 and 324 are rear-perspective normal images, while images 306 and 308 are front-perspective normal images of the 3D asset (e.g., steampunk robot turtle with rusty mechanical parts).

At 108, the method 100 generates, using a reconstruction model, a neural representation of the 3D asset. In at least one embodiment, the reconstruction model is a Transformer-based model that receives, as input, the RGB images generated at 104 and the normal images generated at 106 and provides, as output, the neural representation of the 3D asset. In at least one embodiment, the neural representation of the 3D asset is provided in the form of triplanes, e.g., as represented in the form of a plurality of triplane tokens formed by encoding/compressing triplane information. The triplanes encode, for any given point in a 3D bounding box, a density value, texture values, and material values. In at least one embodiment, the texture values are represented using three channels (one channel for each color red, green, and blue), and the material properties are represented using two channels (one channel for each of metallic and roughness). Additionally, and/or alternatively, the neural representation of the 3D asset can be provided in the form of neural radiance fields (NeRFs).

FIG. 3C illustrates an exemplary neural representation of the 3D asset using triplanes. In at least one embodiment, the neural representation is provided in the form of triplane tokens that encode 3D information across three orthogonal planes 332 (e.g., YZ plane), 334 (e.g., XZ plane), and 336 (e.g., XY plane). This allows for efficient representation of spatial geometry and texture. The information that is encoded in the triplanes includes a density value, texture values, and material values, for any point in a 3D bounding box.

The intermediate 3D asset generation phase 128 receives the neural representation of the 3D asset and performs geometry processing algorithms to produce and further process a 3D mesh.

At 110, the method 100 extracts a dense triangular 3D mesh from the neural representation generated at 108. In at least one embodiment, triplane tokens are processed through multilayer perceptrons (MLPs) to predict neural fields for a signed distance function (SDF) and physically-based rendering (PBR) properties used for SDF-based volume rendering. The neural SDF is converted into a 3D mesh via isosurface extraction (e.g., via an algorithm, such as the marching cubes algorithm, used to extract the dense triangular 3D mesh).

At 112, the method 100 retopologizes the 3D mesh into a simplified quad 3D mesh using a retopology algorithm that receives the dense triangular 3D mesh as input and provides a simplified quad mesh as output. The retopology algorithm examines the dense triangular 3D mesh to identify surface features, curvature, and topology and pairs and merges adjacent triangles of the dense triangular 3D mesh to form the simplified quad 3D mesh.

At 114, the method 100 computes an organized UV map based on the simplified quad mesh. A UV map is a two-dimensional (2D) representation of the surface of an object for texture mapping, where the phrase “UV” refers to coordinates in 2D space, U representing the horizontal axis and V representing the vertical axis. To provide the UV map, the quad 3D mesh is cut along strategically placed seams to enable it to be flattened into a 2D space of the UV map. Each vertex of the quad mesh is assigned a corresponding UV-coordinate in the 2D space of the UV map.

At 116, the method 100 computes a low-resolution texture map and a low-resolution material map of the surface of the quad mesh based on the UV map and the PBR properties encoded by the neural representation generated at 108. In at least one embodiment, the PBR properties (including, e.g., albedo colors and materials properties like roughness and metallic channels) encoded in the neural representation are incorporated into the texture and material maps via UV mapping.

FIG. 3D illustrates an exemplary 3D mesh with low-resolution texture and material maps of the 3D asset to be generated. According to at least one embodiment, the 3D mesh of the asset is a simplified quad 3D mesh using a retopology algorithm that receives the dense triangular 3D mesh as input and provides a simplified quad mesh as output. Portion 342 of the 3D mesh of the 3D asset depicts the simplified quad mesh that is used to represent the 3D asset. Additionally, portion 344 of the 3D mesh of the 3D asset depicts a low-resolution texture map and a low-resolution material map that is disposed on the surface of the simplified quad mesh 342 of the 3D asset. As discussed above, the low-resolution texture map and the low-resolution material map is generated based on the UV map and PBR properties encoded by the neural representation generated at 108.

The 3D asset upscaling phase 130 takes the prompt, the low-resolution texture map, the quad 3D mesh—and optionally the low-resolution material map—as input and generates a final 3D asset as output.

At 118, method 100 renders a multi-view RGB and surface normal image by rasterizing the quad 3D mesh using the low-resolution texture and materials maps. In at least one embodiment, the multi-view surface normal image is an image where each pixel includes channels for x-y-z dimensions of the normal vector for the pixel, that is generated by rasterizing the quad 3D mesh. At 120, method 100 generates high-resolution multi-view images using a third multi-view diffusion model. In accordance with at least one embodiment, the third multi-view diffusion model upscales the rendered multi-view RGB and surface normal image. The third multi-view diffusion model is an upscaling control-net configured to receive, as input, (a) the prompt received at 102, (b) the multi-view RGB and surface normal images rendered at 118, and (c) the low-resolution texture map (and, optionally, material map). The third multi-view diffusion model is conditioned to output high-resolution multi-view images. At 122, the high-resolution multi-view images are used to upscale the resolution of the low-resolution texture and/or material maps to provide high-resolution texture and material maps as output.

Specifically, in at least one embodiment, the third multi-view diffusion model generates high resolution RGB images. The high-resolution RGB images are back-projected onto the texture map and (optionally, the material map) to generate a high-resolution texture map (and, optionally, a high-resolution material map).

FIG. 3E illustrates upscaling the texture map, in accordance with an embodiment. Images 352 of FIG. 3E form the high-resolution multi-view RGB image generated by upscaling the rendered multi-view RGB and surface normal images using the third multi-view diffusion model. The high-resolution multi-view images are back-projected onto the texture map and material map to generate a high-resolution texture map and a high-resolution material map 354.

Method 100 provides, as output at 124, a 3D asset, which includes the quad 3D mesh, a texture map and/or material map, and the UV map (which maps the 2D texture and materials maps to the surface of the quad 3D mesh). In at least one embodiment, method 100 provides, as a component of output at 124, the high-resolution texture map and/or the high-resolution material map.

In at least one embodiment, the first multi-view diffusion model is formed from multiple instances of a base, text-to-image diffusion model having a two-dimensional U-Net architecture. The self-attention layers of each base diffusion model are extended along a “temporal” dimension (in which the number of time-steps is equal to the number of views that the multi-view diffusion model provides in an output, multi-view image) to attend across viewpoints.

In at least one embodiment, the first multi-view diffusion model is trained using a supervised learning process that utilizes a training dataset of labelled natural 2D images as well as 3D object renderings with randomly chosen numbers of views (1, 4, and 8). By training the first multi-view diffusion model with a larger chosen number of views, the multi-view RGB image generated by the first multi-view diffusion model is more accurate. The weights of the first multi-view diffusion model are initialized using a combination of pre-trained weights and specialized initialization strategies. For example, the first multi-view diffusion includes a base text-to-image diffusion model, such as Stable Diffusion v2. In order to handle multiple views simultaneously, the base text-to-image diffusion model can be expanded along the temporal dimension. New components can be added to the base text-to-image diffusion model, such as Correspondence-Aware Attention (CAA) blocks, to enforce consistency across different views of the same scene or object. The CAA blocks are initialized with zero weights, which ensures that the modifications do not disrupt the functionality of the base text-to-image diffusion model.

In at least one embodiment, the first multi-view diffusion model is provided with an input prompt during training. The input prompt can be in the form of text and/or images, describing a 3D asset to be generated. The first multi-view diffusion model generates a set of images based on the received prompt. The generated set of images are compared to ground truth images to determine a performance of the first multi-view diffusion model. In one or more embodiments, standard image quality metrics, such as peak signal-to-noise ratio (PSNR) and structural similarity index (SSIM) can be used to compare the generated set of images to ground truth images and can be incorporated in a loss function. In one or more embodiments, the loss function includes one or more components, such as a diffusion loss, a multi-view loss, and a histogram matching loss. Gradients of the loss function with respect to the weights of the model are calculated and the weights are adjusted to minimize the loss function. This approach ensures that accurate multi-view RGB images are produced that are faithful to both the input text and visual fidelity.

In at least one embodiment, the second multi-view diffusion model is generated by training a base multi-view diffusion model (e.g., the first multi-view diffusion model) with surface normal images. As described previously, surface normal images provide, for each respective pixel thereof, a value for each of three directional channels (i.e., an x-direction, a y-direction, and a z-direction) to encode a direction of a surface normal of the object depicted therein at the respective pixel. The multi-view normal images serve to enhance the visual quality and details of the 3D asset that is ultimately generated. Similar to the first multi-view diffusion model, the second multi-view diffusion model is also trained using a supervised learning process. The weights of the second multi-view diffusion model are initialized using a combination of pre-trained weights and specialized initialization strategies. For example, the second multi-view diffusion includes a new component, such as a ControlNet encoder that is added to the first multi-view diffusion model. The ControlNet encoder supports various input types, including edge detection, pose estimation, and depth maps, providing versatile control over image generation. The ControlNet encoder is initialized with zero weights, which ensures that the modifications do not disrupt the functionality of the base first diffusion model.

In at least one embodiment, the second multi-view diffusion model is provided with an input prompt and a multi-view RGB image as input during training. The second multi-view diffusion model generates a set of surface normal images based on the received input. The generated set of surface normal images are compared to ground truth images to determine a performance of the second multi-view diffusion model. As described above, standard image quality metrics, such as peak signal-to-noise ratio (PSNR) and structural similarity index (SSIM), can be used to compare the generated set of images to ground truth images. The standard image quality metrics can be incorporated in the loss function. The loss function includes multiple components, such as diffusion loss, multi-view loss, and histogram matching loss. Gradients of the loss function with respect to weights of the second multi-view diffusion model are calculated, and the weights are adjusted accordingly.

In at least one embodiment, the third multi-view diffusion model is generated by adding ControlNet encoders to a base diffusion model architecture. The third multi-view diffusion model is trained using a dataset including images, corresponding conditioning inputs (e.g., RGB and surface normal images), and prompts. In one or more embodiments, to train the ControlNet, a trainable copy of a U-Net corresponding to a base diffusion model architecture is created and augmented with additional layers, including zero convolution layers, which are initialized with weights from the U-Net. This ensures that the base diffusion model is not disrupted. In the training phase, the parameters of the trainable copy of the U-Net are updated using loss functions, as described above.

In at least one embodiment, for example, the third multi-view diffusion model is provided with an input prompt, RGB images, and surface normal images as input. The third multi-view diffusion model generates high-resolution multi-view RGB images as output, which can then used to upscale low-resolution texture and material maps. Loss functions, as described above, are used to update the parameters of the third multi-view diffusion model.

In at least one embodiment, the reconstruction model is trained using large-scale imagery and 3D asset data. In at least one embodiment, the reconstruction model is trained using supervised learning on depth, normal, mask, albedo, and material channels through SDF-based volume rendering, with outputs rendered from artist-generated meshes. Additionally, object edges are masked out during loss computation to avoid noisy samples caused by aliasing. To smooth noisy gradients across samples, an exponential moving average (EMA) can be applied to aggregate the final reconstruction model parameters.

In at least one embodiment, for example, the reconstruction model is trained to reconstruct 3D objects representing shapes as signed distance fields (SDFs). SDFs are a mathematical way to define surfaces where each point in 3D space stores its distance to the nearest surface (negative inside objects, positive outside). The training process of the reconstruction model uses differentiable rendering, a technique that converts this 3D representation into 2D images while allowing error correction through backpropagation. In one or more embodiments, the key steps of the training the reconstruction model include sphere tracing, silhouette matching, photometric loss, and eikonal regularization. For example, the training starts with a simple shape (like a sphere) and refines it using 2D images as guidance, avoiding the need for 3D training data. This enables realistic reconstructions from ordinary photos through geometric constraints and image comparisons. This approach results in efficient and high-quality 3D reconstruction from sparse inputs.

In at least one embodiment, the reconstruction model receives, during training, a multi-view RGB image and a multi-view surface normal image as input and produces a 3D neural representation as output. In one or more embodiments, the generated 3D neural representation is compared to ground truths using a loss function that considers one or more of geometric accuracy, photometric consistency, silhouette alignment, and/or benchmark comparisons. By parameters based on gradients of the loss function, the reconstruction model is trained to achieve accurate geometry, realistic appearance, and efficient performance. Thus, the reconstruction model of the present disclosure is able to generate an accurate 3D neural representation of the asset based on the multi-view RGB image and the multi-view surface normal images.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

FIG. 2 illustrates a block diagram of an example system suitable for use in implementing some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by one or more processors executing instructions stored in memory. Furthermore, persons of ordinary skill in the art will understand that any system that performs the operations of the system 200 is within the scope and spirit of embodiments of the present disclosure.

System 200 includes a first module 210, a second module 212, and a third module 214 that work together to generate a 3D asset based on a received prompt.

In accordance embodiments of the present disclosure, the first module 210 receives a prompt to generate a 3D asset as an input and generates a neural representation of the 3D asset as output. In some cases, the prompt can be a text prompt. The text prompt can provide a written description of an object for which the 3D asset that is to be generated. Additionally, and/or alternatively, the prompt can include an image for a which the 3D asset is to be generated. In such cases, the image can serve as a reference of the object for which the 3D asset is to be generated.

In some embodiments, the prompt is provided to a multi-view diffusion model 202 of the first module 210. The multi-view diffusion model 202 generates a multi-view RGB image of the object for which the 3D asset is to be generated based on the received prompt.

The multi-view RGB image and the prompt are provided to the multi-view ControlNet 204 to generate a multi-view normal image.

The generated RGB images and the generated normal images are provided as input to a reconstruction model 206. The reconstruction model 206 takes the generated RGB images and normal images as input and generates a neural representation of the 3D asset as output. In some embodiments, the reconstruction model 206 can be a Transformer-based model that provides latent 3D tokens (e.g., triplane tokens) as output based on the generated multi-view RGB and normal images. In some embodiments, the latent 3D tokens encode a 3D geometry, RGB colors, and material properties.

In accordance with embodiments of the present disclosure, the second module 212 takes the 3D representation of the 3D asset and performs geometry processing algorithms to further produce a 3D mesh and 2D maps (e.g., texture map and material map).

In some embodiments, the second module 212 uses geometry processing algorithms to produce the 3D mesh from the neural representation. The geometry processing algorithms include iso-surface extraction and mesh processing. For example, the second module 212 can process the latent 3D tokens through multilayer perceptrons (MLPs) to provide neural fields for volumetric data in the form of a signed distance function (SDF)-grid. Subsequently, the second module 212 can use an algorithm, such as a Marching Cube algorithm, to process the SDF-grid to extract a triangular mesh. The Marching Cube algorithm can traverse the scalar field provided by the SDF-grid and identify where a surface of the object is located to generate triangles that approximate the surface of the object. In some embodiments, the resulting triangular mesh consists of vertices, edges, and faces that collectively represent the surface of the object. Each face is a triangle defined by three vertices, with edges connecting these vertices. This triangular mesh structure provides a discrete approximation of the continuous surface implied by the 3D representation captured by the latent 3D tokens.

The second module 212 also retopologizes the triangular mesh structure using a retopology algorithm to provide a simplified quad 3D mesh as output. The retopology algorithm can examine the triangular mesh received as input to identify surface features, curvature, and topology. The retopology algorithm can pair and merge adjacent triangles to form the quad 3D mesh. For example, the retopology algorithm can prioritize combining merging triangles of the triangular mesh to form quads that align with a surface curvature of the object for which the 3D asset is to be generated. Additionally, the retopology algorithm can merge triangles that share an edge and have similar surface normals. The retopology algorithms can also aim to combine triangular meshes to form 3D quad meshes with angles close to ninety (90) degrees and similar edge lengths.

Using the 3D quad mesh, the second module 212 computes an organized UV map based on the simplified quad 3D mesh. In some embodiments, a UV map refers to a two-dimensional (2D) representation of the surface of an object for texture mapping. The phrase “UV” refers to coordinates in 2D space, where U represents the horizontal axis, and V represents the vertical axis. In some cases, generating the UV map includes examining the surface of the object for which the 3D asset is to be generated. The quad mesh generated in the previous step is examined and cut along strategically placed seams of the quad mesh and flatten the quad mesh into a 2D space of the UV map. Each vertex of the quad mesh is assigned corresponding UV coordinates in the 2D space of the UV map.

The second module 212 generates a texture map and a material map of the surface of the quad mesh based on the UV map and the 3D mesh. In some embodiments, a texture image is created based on the UV map. For example, an algorithm can be used to generate the texture image in 2D or texture details such as colors, patterns, or surface properties (e.g., glossiness or transparency) from the neural representation. In such examples, the texture details are generated to correspond to specific areas of the UV map. The second module 212 utilizes the texture and material map to render a second multi-view image.

In accordance with embodiments of the present disclosure, the third module 214 takes the texture map, material map, and the 3D quad mesh as input and generates the final 3D asset. In some embodiments, the third module 214 utilizes a third multi-view diffusion model to generate a high-resolution multi-view image from the second multi-view image, texture and/or material maps, and the 3D quad mesh as generated previously.

In some examples, the third module 214 upscales the texture maps and material maps based on the second multi-view image. In some embodiments, the prompt and the second multi-view image are provided as input to the third multi-view diffusion model. The third multi-view diffusion model utilizes the input to generate a high-resolution multi-view image. Specifically, the third multi-view diffusion model super-resolves rendered multi-view RGB images to a higher resolution, conditioned on the input text. The high resolution RGB images are back-projected on the texture and material maps to generate high-resolution texture and material maps for the 3D asset.

FIG. 2B depicts extending the self-attention layer in a base diffusion model to create a multi-view diffusion model, according to an embodiment. In conventional diffusion models, a single view image is synthesized, and self-attention layers attend only to other pixels in that image to compute attention weights. In order to capture dependencies and relationships between different views of a multi-view image, self-attention layers of each base diffusion model can be expanded in a viewpoint dimension to allow them to attend to information in other viewpoints.

Each self-attention layer includes learnable (during trained)/learned (during inference) key, query, and value tensors and computes, attention scores, attention weights, and a weighted sum of value vectors for each respective pixel and/or patch. To enable the self-attention layers to attend to information in other viewpoints, the key and value tensors are expanded by adding an additional viewpoint dimension. In this manner, each location (e.g., pixel or patch) in a particular image can attend to both other locations (e.g., pixels or patches) in that same image and locations (e.g., pixels or patches) in other images corresponding to different view points. During the training process, the parameters of the key and value tensors are updated to enable effective capture of inter-view relationships.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

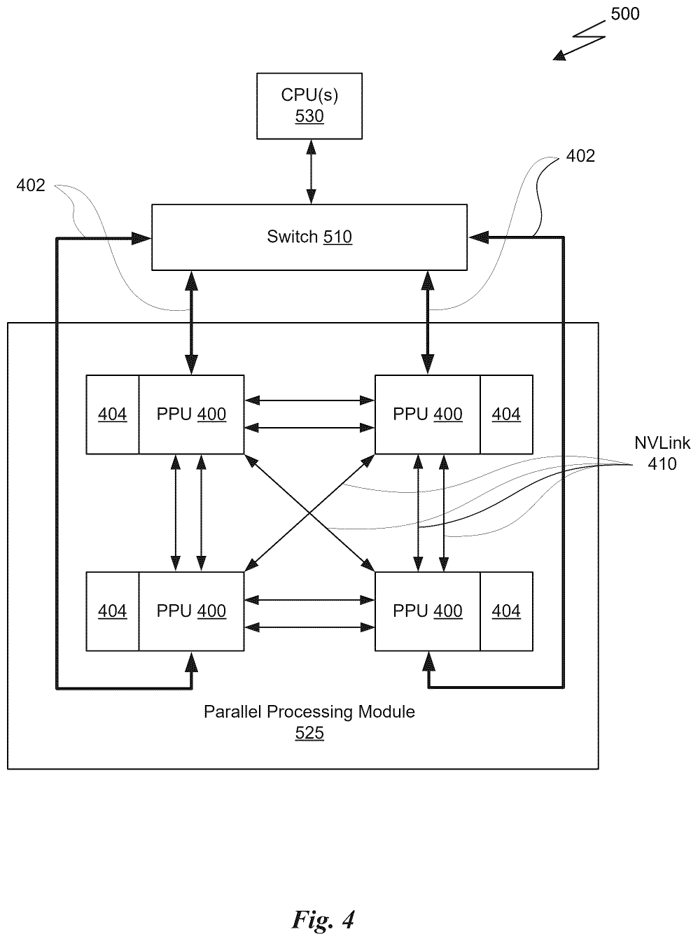

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

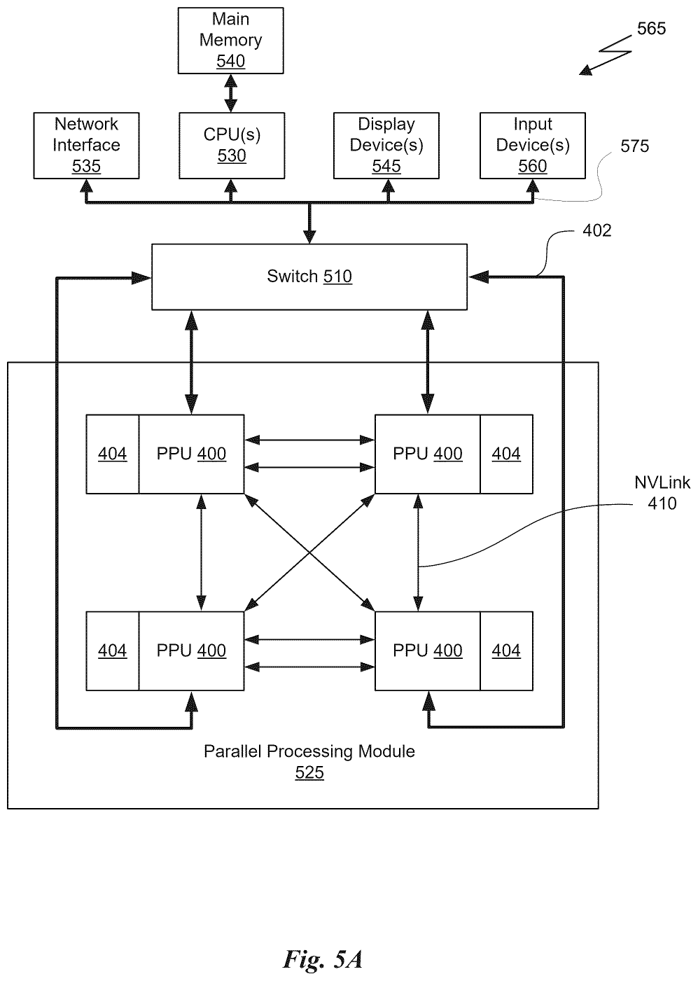

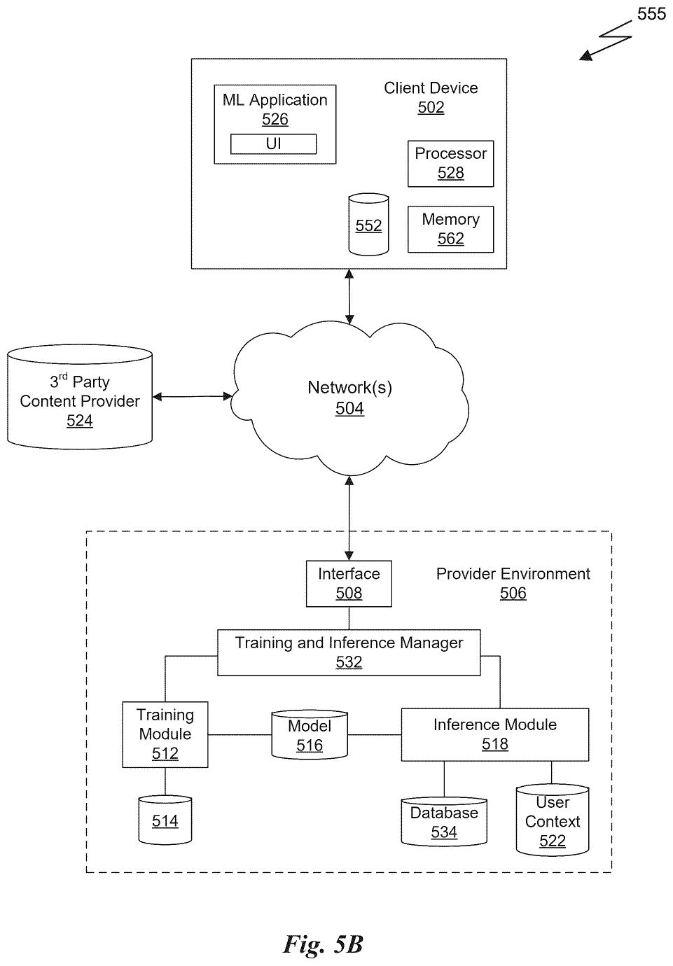

FIG. 5A illustrates an exemplary system 565 in which the various architecture and/or functionality of the various previous embodiments may be implemented. The exemplary system 565 may be configured to implement the method 300 shown in FIG. 3.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system.

Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA GeForce Now (GFN), Google Stadia, and the like.

### Example Streaming System

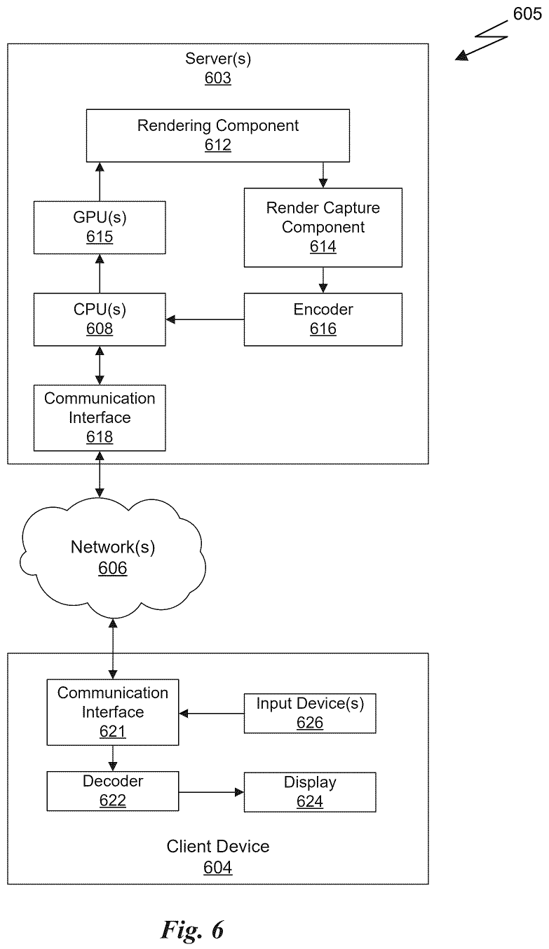

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A system comprising:
processing circuitry to generate a three-dimensional (3D) asset using one or more neural networks, the processing circuitry being configured to implement:
a first multi-view diffusion model configured to receive and process an input prompt to generate a muti-view image of an object for which the 3D asset is to be generated;
a second multi-view diffusion model configured to receive and process the input prompt and the multi-view image to generate a multi-view surface normal image of the object;
a 3D reconstruction engine configured to receive and process the multi-view image and the multi-view surface normal image to generate an intermediate 3D representation of the object, wherein the intermediate 3D representation comprises a polygon mesh and a low-resolution texture map;
a rendering engine configured to render a second multi-view image based on the intermediate 3D representation of the object; and
a third multi-view diffusion model configured to receive and process the input prompt and the rendered second multi-view image to generate a high-resolution multi-view image; and
one or more memories to store parameters associated with the one or more neural networks,
wherein the 3D asset comprises the polygon mesh and a high-resolution texture map generated by upscaling, by the 3D reconstruction engine, the low-resolution texture map based on the high-resolution multi-view image.

2. The system of claim 1, wherein the input prompt is text, an image, or both.

3. The system of claim 1, wherein the multi-view surface normal image generated by the second multi-view diffusion model comprises surface normals of the object in the multi-view image, and wherein the second multi-view diffusion model is conditioned on both the multi-view image and the received prompt.

4. The system of claim 1, wherein the 3D reconstruction engine configured to generate the intermediate 3D representation of the object, is further configured to:
generate a 3D neural representation of the object based on the multi-view image and the multi-view surface normal image; and
generate the polygon mesh and the low-resolution texture map based on the 3D neural representation of the object.

5. The system of claim 4, wherein the 3D neural representation is generated based on a Transformer-based model.

6. The system of claim 4, wherein the 3D reconstruction engine is further configured to generate a low-resolution material map based on the 3D neural representation of the object.

7. The system of claim 4, wherein the low-resolution texture map and a low-resolution material map are mapped to the polygon mesh using a UV map.

8. The system of claim 7, wherein the 3D reconstruction engine is further configured to:
extract a dense triangular mesh based on the 3D neural representation;
retopologize the dense triangular mesh to a simplified 3D quad mesh; and
generate the UV map based on the simplified 3D quad mesh and the 3D neural representation.

9. The system of claim 8, wherein the UV map is generated by assigning each vertex of the simplified 3D quad mesh with a corresponding UV-coordinate in a 2D space of the UV map.

10. The system of claim 8, wherein the 3D reconstruction engine extracts the dense triangular mesh from the 3D neural representation using a marching cubes algorithm.

11. A method for generating a three-dimensional (3D) asset, the method comprising:
receiving and processing, using a first multi-view diffusion model, an input prompt to generate a muti-view image of an object for which the 3D asset is to be generated;
receiving and processing, using a second multi-view diffusion model, the input prompt and the multi-view image to generate a multi-view surface normal image of the object;
receiving and processing, using a 3D reconstruction engine, the multi-view image and the multi-view surface normal image to generate an intermediate 3D representation of the object, wherein the intermediate 3D representation comprises a polygon mesh and a low-resolution texture map;
rendering, using a rendering engine, a second multi-view image based on the intermediate 3D representation;
receiving and processing, using a third multi-view diffusion model the input prompt, the rendered second multi-view image, and the low-resolution texture map to generate a high-resolution multi-view image;
upscaling, using the 3D reconstruction engine, the low-resolution texture map based on the high-resolution multi-view image; and
providing the 3D asset, the 3D asset comprising the polygon mesh and the upscaled texture map.

12. The method of claim 11, wherein the input prompt is text, an image, or both.

13. The method of claim 11, wherein the multi-view surface normal image generated by the second multi-view diffusion model comprises surface normals of the object in the multi-view image, and wherein the second multi-view diffusion model is conditioned on both the multi-view image and the received input prompt.

14. The method of claim 11, wherein the rendering engine is based on a Transformer-based model.

15. The method of claim 11, wherein generating the intermediate 3D representation of the object comprises:
generating a 3D neural representation of the object based on the multi-view image and the multi-view surface normal image; and
generating the polygon mesh and the low-resolution texture map based on the 3D neural representation of the object.

16. The method of claim 15, further comprising generating a low-resolution material map based on the 3D neural representation of the object.

17. The method of claim 11, wherein the low-resolution texture map and a low-resolution material map are mapped to the polygon mesh using a UV map.

18. The method of claim 17, wherein the polygon mesh generated by:
extracting a dense triangular mesh based on a 3D neural representation;
retopologizing the dense triangular mesh to a simplified 3D quad mesh; and generating the UV map based on the simplified 3D quad mesh and the 3D neural representation.

19. The method of claim 18, wherein the UV map is generated by assigning each vertex of the simplified 3D quad mesh with a corresponding UV-coordinate in a 2D space of the UV map.

20. A non-transitory computer-readable medium having stored thereon instructions that, when executed by processing circuitry, cause the processing circuitry to perform a method for generating a three-dimensional (3D) asset, the method comprising:
receiving and processing, using a first multi-view diffusion model, an input prompt to generate a muti-view image of an object for which the 3D asset is to be generated;
receiving and processing, using a second multi-view diffusion model, the input prompt and the multi-view image to generate a multi-view surface normal image of the object;
receiving and processing, using a 3D reconstruction engine, the multi-view image and the multi-view surface normal image to generate an intermediate 3D representation of the object, wherein the intermediate 3D representation comprises a polygon mesh and a low-resolution texture map;
rendering, using a rendering engine, a second multi-view image based on the intermediate 3D representation;
receiving and processing, using a third multi-view diffusion model the input prompt, the rendered second multi-view image, and the low-resolution texture map to generate a high-resolution multi-view image;
upscaling using the 3D reconstruction engine, the low-resolution texture map based on the high-resolution multi-view image; and
providing the 3D asset, the 3D asset comprising the polygon mesh and the upscaled texture map.

21. The non-transitory computer-readable medium of claim 20, wherein generating the intermediate 3D representation of the object comprises:
generating a 3D neural representation of the object based on the multi-view image and the multi-view surface normal image; and
generating the polygon mesh and the low-resolution texture map based on the 3D neural representation of the object.

22. A system comprising:
processing circuitry to generate a three-dimensional (3D) asset using one or more neural networks, the processing circuitry being configured to implement:
a first multi-view diffusion model configured to receive and process an input prompt to generate a muti-view image of an object for which the 3D asset is to be generated;
a second multi-view diffusion model configured to receive and process the input prompt and the multi-view image to generate a multi-view surface normal image of the object;
a 3D reconstruction engine configured to receive and process the multi-view image and the multi-view surface normal image to generate an 3D representation of the object, wherein the 3D representation comprises a polygon mesh and a texture map; and
one or more memories to store parameters associated with the one or more neural networks.

23. The system of claim 22, wherein the 3D reconstruction engine configured to generate the 3D representation of the object, is further configured to:
generate a 3D neural representation of the object based on the multi-view image and the multi-view surface normal image; and
generate the polygon mesh and the texture map based on the 3D neural representation of the object.

24. The system of claim 23, wherein the 3D reconstruction engine is further configured to generate a material map based on the 3D neural representation of the object.

25. The system of claim 24, wherein the texture map and the material map are mapped to the polygon mesh using a UV map.

26. The system of claim 23, wherein the 3D reconstruction engine is further configured to:
extract a dense triangular mesh based on the 3D neural representation;
retopologize the dense triangular mesh to a simplified 3D quad mesh; and
generate a UV map based on the simplified 3D quad mesh and the 3D neural representation.

27. A system comprising:
processing circuitry to generate a three-dimensional (3D) asset using one or more neural networks, the processing circuitry being configured to implement:
a 3D reconstruction engine configured to receive and process a multi-view image and a multi-view surface normal image to generate an intermediate 3D representation, wherein the intermediate 3D representation comprises a polygon mesh and a low-resolution texture map;
a rendering engine configured to render a second multi-view image based on the intermediate 3D representation of the object; and
a third multi-view diffusion model configured to receive and process the input prompt and the rendered second multi-view image to generate a high-resolution multi-view image; and
one or more memories to store parameters associated with the one or more neural networks,
wherein the 3D asset comprises the polygon mesh and a high-resolution texture map generated by upscaling, by the 3D reconstruction engine, the low-resolution texture map based on the high-resolution multi-view image.

28. The system of claim 27, wherein the multi-view surface normal image comprises surface normals of the object in the multi-view image.

29. The system of claim 27, wherein the 3D reconstruction engine configured to generate the intermediate 3D representation, is further configured to:
generate a 3D neural representation based on the multi-view image and the multi-view surface normal image; and
generate the polygon mesh and the low-resolution texture map based on the 3D neural representation of the object.

30. The system of claim 29, wherein the 3D reconstruction engine is further configured to:
extract a dense triangular mesh based on the 3D neural representation;
retopologize the dense triangular mesh to a simplified 3D quad mesh; and
generate the UV map, which maps the low-resolution texture map to the 3D quad mesh.
